(19) United States
(12) Patent Application Publication
(10) Pub. No.: US 2020/0146204 A1
(43) Pub. Date: May 14, 2020

(54) Furrow Opener of Wide Seedling Row Planter

(71) Applicant: Shandong University of Technology, Zibo (CN)

(72) Inventors: Duanyang Geng, Zibo (CN); Haocheng Geng, Zibo (CN); Qian Wang, Zibo (CN); Yangcheng Liu, Zibo (CN); Xingrui Yu, Zibo (CN); Shandong Yang, Zibo (CN); Chengqian Jin, Zibo (CN)

(21) Appl. No.: 16/563,648

(22) Filed: Sep. 6, 2019

(30) Foreign Application Priority Data
Nov. 13, 2018 (CN) 201811345171.2

(51) Int. Cl. A01C 5/06

(52) U.S. Cl. CPC A01C 5/062

(57) ABSTRACT

The present invention relates to the technical field of agricultural machines, specifically to a furrow opener of a wide seedling row seeder, which includes a frame, where a power device is arranged at the upper portion of the frame, two symmetrically arranged connecting plates are arranged at the lower portion of the frame, a furrow opener shaft is arranged between the two connecting plates, the furrow opener shaft is connected with the power device through a driving device, the furrow opener shaft is fixedly connected with a plurality of furrow opening blades uniformly distributed on the circumferential surface of the furrow opener shaft, a main body of the furrow opening blade is in shape of a rectangular plate, the furrow opening blade is formed by carrying out a twisting treatment on a plate-shaped structure, a head end of the furrow opening blade is vertical to the center line of the furrow opener shaft, a tail end of the furrow opening blade is in parallel with the center line of the furrow opener shaft, a bent tip is arranged at the tail end of the furrow opening blade, the bent tip is bent towards an advancing direction of the corresponding furrow opening blade, two sides of the furrow opening blade are respectively and fixedly connected with a baffle, the baffle is in shape of a circular ring, and the bent tip extends from the outer sides of the baffle. The furrow opener of a wide seedling row seeder of the present invention facilitates consistency of the widths and depths of opened furrows.

This application claims priority to Chinese application number 201811345171.2, filed Nov. 13, 2018, with a title of FURROW OPENER OF WIDE SEEDLING ROW PLANTER. The above-mentioned patent application is incorporated herein by reference in its entirety.

### TECHNICAL FIELD

The present relates to the technical field of agricultural machines, and specifically to a furrow opener of a wide seedling row seeder.

### BACKGROUND

A seeder is a planting machine using crop seeds as the seeding objective and is used for seeding some crops. According to seeding methods, the seeder can be divided into the following types: a seed broadcaster, a drill, a hill-drop planter, a precision seeder and a combined seeder.

Where the drill is mainly used for seeding small-scale seeds such as grain seeds, vegetable seeds, grass seeds and the like, and a grain drill is commonly used. During operation, road wheels drive a feed wheel to rotate so that seeds in a seed box are discharged into a seed drop tube according to a required seeding quantity, next the seeds fall into an opened furrow through a furrow opener and then are covered and compacted by a soil-covering and compacting device. After the seedlings emerge, the crops form parallel and equidistant lines. Drills, which are applied to different crops, have basically similar structures except for utilizing different types of seed metering devices and furrow openers, and each of the drills is generally composed of a frame, a traction or suspension device, a seed box, a seed metering device, a driving device, a seed drop tube, a furrow opener, a row marker, road wheels, a soil-covering and compacting device and the like. The seeding quality is mainly influenced by the seed metering device and the furrow opener.

Currently, a grain seeder mostly utilizes a structure including a disc furrow opener or an acute-angle furrow opener and the like, and these furrow openers merely can open a V-shaped seedbed with a lower middle part and two higher sides, which is easy to cause inconsistency of grain seeding depths, further causes difference of seedling emergence times, and finally influences the yield of grains, resulting in reduction of the yield.

### SUMMARY

A technical problem to be solved by the present invention is to provide a furrow opener of a wide seedling row seeder in order to overcome the defects of the prior art.

To solve the above technical problems, the present invention provides the following technical solution.

A furrow opener of a wide seedling row seeder includes a frame, a power device is arranged at the upper portion of the frame, two symmetrically arranged connecting plates are arranged at the lower portion of the frame, a furrow opener shaft is arranged between the two connecting plates, the furrow opener shaft vertically passes through the two connecting plates and is respectively connected with the two connecting plates, the furrow opener shaft is connected with the power device through a driving device, and the power device transfers power to the furrow opener shaft through the driving device. The furrow opener shaft is fixedly connected with a plurality of furrow opening blades uniformly distributed on the circumferential surface of the furrow opener shaft, a main body of the furrow opening blade is in shape of a rectangular plate, and the furrow opening blade is formed by carrying out a twisting treatment on a plate-shaped structure, that is, the plate-shaped structure is twisted to form an abnormal structure; and a head end of the furrow opening blade is vertical to the center line of the furrow opener shaft, and a tail end of the furrow opening blade is in parallel with the center line of the furrow opener shaft. Additionally, a bent tip is arranged at the tail end of the furrow opening blade, a section shape of the bent tip is right triangle, a certain included angle is formed between the bent tip and the tail end of the furrow opening blade, and the bent tip is bent towards a rotation direction of the corresponding furrow opening blade. Two sides of the furrow opening blade are respectively and fixedly connected with a baffle, each baffle is in shape of a circular ring, and the bent tip extends from the outer sides of the baffle.

The hypotenuse of the bent tip is provided with a toothed cutting edge part, and the right-angle sides of the bent tip are in parallel with the baffle. The toothed cutting edge parts are beneficial to achieving a self-sharpening function and ensure continuous sharpness of a soil cutting edge part of the furrow opener.

In order to ensure that rotationally cut soil uniformly falls on the two sides of a seedbed, the two adjacent furrow opening blades have opposite twisting directions, and are symmetrically distributed.

Preferably, the included angle between the bent tip and the corresponding tail end of the furrow opening blade is 25-35 degrees.

The power device includes a gearbox, the gearbox is connected with a power output shaft of a tractor, the gearbox is connected with a power input sprocket through a first chain, the power input sprocket is concentrically mounted on a countershaft, the countershaft is mounted below the frame, the countershaft is concentrically equipped with a small sprocket, the small sprocket is connected with a large sprocket through a second chain, the large sprocket is concentrically mounted on the furrow opener shaft, and the large sprocket is fastened on the furrow opener shaft through a nut.

The two ends of the furrow opener shaft are respectively connected with the two connecting plates through two bearing blocks.

A seed box is arranged at the upper portion of the frame, a seed guiding tube is arranged below the seed box, the seed guiding tube is arranged below the frame, the lower end of the seed guiding tube is level with the lower edges of the baffle of the furrow opener, the tail end of the seed guiding tube is bent in a direction opposite to the bending direction of the bent tip of the furrow opening blade.

The beneficial effects of the present invention are:

1. in the present invention, the power device is utilized to drive the furrow opener to actively rotate and cut soil, and open furrows, thereby achieving layer soil cutting, facilitating to cut up the soil, preventing relatively larger soil blocks from generating, and creating the conditions for consistency of the following soil covering;

2. the furrow opener of the present invention utilizes twisted furrow opening blades with the width of 12-14 cm, thereby ensuring the width of each opened furrow to be 12-14 cm, and facilitating to ensure the consistency of the widths and depths of the opened furrows; due to utilization of the twisted blades, the cut soil can slide upwards along the twisted blades, and uniformly slide down and fall on one side of the seedbed along with the rotation of the twisted furrow opening blades; furthermore, in order to ensure the uniformity of the soil on the two side of the seedbed, the two adjacent furrow opening blades have opposite twisting directions, thereby ensuring that the rotationally cut soil is uniformly distributed on the two sides of the seedbed, and creating the conditions for the following soil covering; and

3. in the present invention, the tail end of furrow opener utilizes the bent tip, and the cutting edge part of the bent tip is of a beveled-edge toothed triangular structure, where the beveled edge facilitates achievement of soil sliding cutting and reduction of furrow opening resistance; the toothed cutting edge part facilitates achievement of the self-sharpening function, ensures the continuous sharpness of the soil cutting edge part of the furrow opener, and further reducing the furrow opening resistance.

### BRIEF DESCRIPTION OF THE DRAWINGS

The accompanying drawings are provided for further understanding of the present invention, and constitute a part of the specification. The exemplary embodiments and illustrations thereof of the present invention are intended to explain the present invention, but do not constitute limitations to the present invention. In the accompanying drawings.

FIG. 1 is a schematic structural diagram of the present invention.

FIG. 2 is a left view of FIG. 1.

FIG. 3 is a stereo schematic structural diagram of furrow opening blades and baffles in FIG. 1.

FIG. 4 is a schematic structural diagram of a position A in FIG. 3 being partially enlarged.

In the drawings: 1—frame, 2—small sprocket, 3—countershaft, 4—shaft seat, 5—second chain, 6—furrow opening blade, 61—head end of the furrow opening blade, 62—tail end of the furrow opening blade, 7—bearing block, 8—nut, 9—furrow opener shaft, 10—large sprocket, 11—baffle, 12—bent tip, 13—seed box, 14—connecting plate, 15—seed guiding tube. 16—gearbox, 17—power input sprocket, and 18—cutting edge part.

### DETAILED DESCRIPTION

The following describes preferable embodiments of the present invention with reference to the accompanying drawings. It should be understood that the preferable embodiments described herein are merely used to describe and explain the present invention, rather than to limit the present invention.

### Embodiment

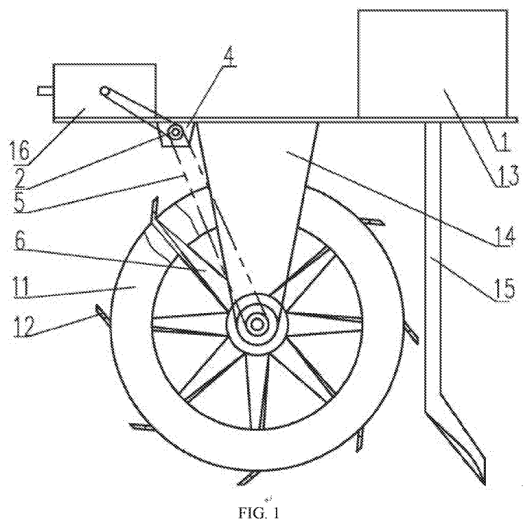

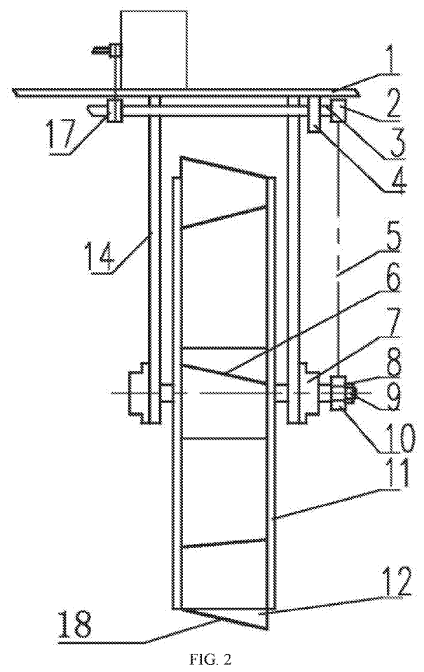

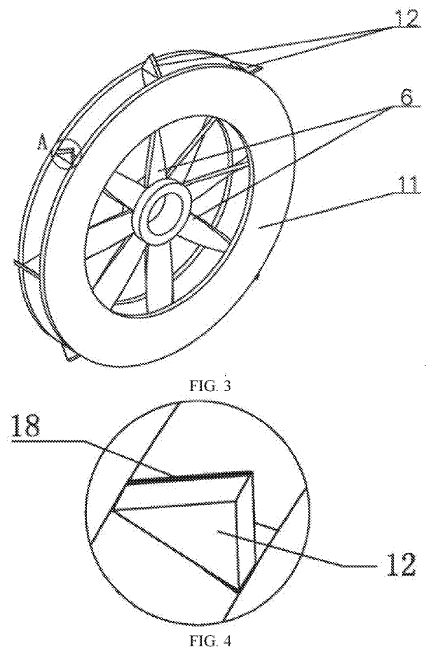

As shown in FIG. 1 to FIG. 4, a furrow opener of a wide seedling row seeder includes a frame 1, a power device is arranged at the upper portion of the frame 1, two symmetrically arranged connecting plates 14 are arranged at the lower portion of the frame 1, a furrow opener shaft 9 is arranged between the two connecting plates 14, the furrow opener shaft 9 vertically passes through the two connecting plates 14, and two ends of the furrow opener shaft 9 are respectively connected with the two connecting plates 14 through two bearing blocks 7.

The furrow opener shaft 9 is connected with the power device through a driving device, the power device includes a gearbox 16, the gearbox 16 is connected with a power output shaft of a tractor, the gearbox 16 is connected with a power input sprocket 17 through a first chain, the power input sprocket 17 is concentrically mounted on a countershaft 3, the countershaft 3 is mounted below the frame 1 through the shaft seat 4, the countershaft 3 is concentrically equipped with a small sprocket 2, the small sprocket 2 is connected with a large sprocket 10 through a second chain 5, the large sprocket 10 is concentrically mounted on the furrow opener shaft 9, and the large sprocket 10 is fastened on the furrow opener shaft 9 through a nut 8.

The furrow opener shaft 9 is fixedly connected with a plurality of furrow opening blades 6 uniformly distributed on the circumferential surface of the furrow opener shaft 9, a main body of the furrow opening blade 6 is in shape of a rectangular plate and has a width of 12-14 cm. The furrow opening blade 6 is formed by carrying out a twisting treatment on a plate-shaped structure, that is, the plate-shaped structure is twisted to 90 degrees to form an abnormal structure, thereby ensuring that the rotationally cut soil falls on the two sides of a seedbed along the furrow opening blades 6. The head end of the furrow opening blade 61 is vertical to the center line of the furrow opener shaft 9, and the tail end of the furrow opening blade 62 is in parallel with the center line of the furrow opener shaft 9. The two adjacent furrow opening blades 6 have opposite twisting directions, and are symmetrically distributed, so that the triangular structures of the bent tips 12 of the tail ends of the furrow opening blade 62 are twisted to form left-right alternative changing structures.

Additionally, the bent tip 12 is arranged at the tail end of the furrow opening blade 62, a section shape of the bent tip 12 is right triangle, an included angle of 25-35 degrees is formed between the bent tip 12 and the tail end of the furrow opening blade 62, and the bent tip 12 is bent towards a rotationally advancing direction of the corresponding furrow opening blade 6. Two sides of the furrow opening blade 6 are respectively and fixedly connected with a baffle 11, the baffle 11 is in shape of a circular ring, and the bent tip 12 extends 5-8 cm from the outer sides of the baffle 11. The hypotenuse of the bent tip 12 is provided with a toothed cutting edge part 18, and the right-angle sides of the bent tip 12 are in parallel with the baffle 11. When the bent tip 12 is manufactured, firstly the corresponding furrow opening blade 6 is bent, next an angle of the corresponding furrow opening blade 6 is cut off to form a beveled edge, and then the formed beveled edge is processed to form a toothed cutting edge part 18.

A seed box 13 is arranged at the upper portion of the frame 1, a seed guiding tube 15 is arranged below the seed box 13, the seed guiding tube 15 is arranged below the frame 1, the lower end of the seed guiding tube 15 is level with the lower edges of the baffle 11 of the furrow opener, the tail end of the seed guiding tube 15 is bent in a direction opposite to the bending direction of the bent tip 12 of the furrow opening blade.

1. A furrow opener of a wide seedling row seeder, comprising a frame (1), wherein a power device is arranged at the upper portion of the frame (1), two symmetrically arranged connecting plates (14) are arranged at the lower portion of the frame (1), a furrow opener shaft (9) is arranged between the two connecting plates (14), the furrow opener shaft (9) vertically passes through the two connecting plates (14) and is respectively connected with the two connecting plates (14), the furrow opener shaft (9) is connected with the power device through a driving device, the furrow opener shaft (9) is fixedly connected with a plurality of furrow opening blades (6) uniformly distributed on the circumferential surface of the furrow opener shaft (9), a main body of the furrow opening blade (6) is in shape of a rectangular plate, and the furrow opening blade (6) is formed by carrying out a twisting treatment on a plate-shaped structure, a head end of the furrow opening blade (61) is vertical to the center line of the furrow opener shaft (9), a tail end of the furrow opening blade (62) is in parallel with the center line of the furrow opener shaft (9), a bent tip (12) is arranged at the tail end of the furrow opening blade (62), a section shape of the bent tip (12) is right triangle, a certain included angle is formed between the bent tip (12) and the tail end of the corresponding furrow opening blade (6), the bent tip (12) is bent towards a rotation direction of the corresponding furrow opening blade (6), two sides of the furrow opening blade (6) are respectively and fixedly connected with a baffle (11), each baffle (11) is in shape of a circular ring, and the bent tip (12) extends from the outer sides of the baffle (12).

2. The furrow opener of a wide seedling row seeder according to claim 1, wherein the hypotenuse of the bent tip (12) is provided with a toothed cutting edge part (18), and the right-angle sides of the bent tip (12) are in parallel with the baffle (11).

3. The furrow opener of a wide seedling row seeder according to claim 1, wherein the two adjacent furrow opening blades (6) have opposite twisting directions, and are symmetrically distributed.

4. The furrow opener of a wide seedling row seeder according to claim 1, wherein the included angle between the bent tip (12) and the tail end of the corresponding furrow opening blade (6) is 25-35 degrees.

5. The furrow opener of a wide seedling row seeder according to claim 1, wherein the power device comprises a gearbox (16), the gearbox (16) is connected with a power output shaft of a tractor, the gearbox (16) is connected with a power input sprocket (17) through a first chain, the power input sprocket (17) is concentrically mounted on a countershaft (3), the countershaft (3) is mounted below the frame (1), the countershaft (3) is concentrically equipped with a small sprocket (2), the small sprocket (2) is connected with a large sprocket (10) through a second chain (5), the large sprocket (10) is concentrically mounted on the furrow opener shaft (9), and the large sprocket (10) is fastened on the furrow opener shaft (9) through a nut (8).

6. The furrow opener of a wide seedling row seeder according to claim 1, wherein the two ends of the furrow opener shaft (9) are respectively connected with the two connecting plates (14) through two bearing blocks (7).

7. The furrow opener of a wide seedling row seeder according to claim 1, wherein a seed box (13) is arranged at the upper portion of the frame (1), a seed guiding tube (15) is arranged below the seed box (13), the seed guiding tube (15) is arranged below the frame (1), the lower end of the seed guiding tube (15) is level with the lower edges of the baffle (11) of the furrow opener, the tail end of the seed guiding tube (15) is bent in a direction opposite to the bending direction of the bent tip (12) of the furrow opening blade (6).

8. The furrow opener of a wide seedling row seeder according to claim 2, wherein the two adjacent furrow opening blades (6) have opposite twisting directions, and are symmetrically distributed.

9. The furrow opener of a wide seedling row seeder according to claim 2, wherein the included angle between the bent tip (12) and the tail end of the corresponding furrow opening blade (6) is 25-35 degrees.

10. The furrow opener of a wide seedling row seeder according to claim 2, wherein the power device comprises a gearbox (16), the gearbox (16) is connected with a power output shaft of a tractor, the gearbox (16) is connected with a power input sprocket (17) through a first chain, the power input sprocket (17) is concentrically mounted on a countershaft (3), the countershaft (3) is mounted below the frame (1), the countershaft (3) is concentrically equipped with a small sprocket (2), the small sprocket (2) is connected with a large sprocket (10) through a second chain (5), the large sprocket (10) is concentrically mounted on the furrow opener shaft (9), and the large sprocket (10) is fastened on the furrow opener shaft (9) through a nut (8).

11. The furrow opener of a wide seedling row seeder according to claim 2, wherein the two ends of the furrow opener shaft (9) are respectively connected with the two connecting plates (14) through two bearing blocks (7).

12. The furrow opener of a wide seedling row seeder according to claim 2, wherein a seed box (13) is arranged at the upper portion of the frame (1), a seed guiding tube (15) is arranged below the seed box (13), the seed guiding tube (15) is arranged below the frame (1), the lower end of the seed guiding tube (15) is level with the lower edges of the baffle (11) of the furrow opener, the tail end of the seed guiding tube (15) is bent in a direction opposite to the bending direction of the bent tip (12) of the furrow opening blade (6).
